(19) United States
(12) Patent Application Publication
(10) Pub. No.: US 2024/0328712 A1
(43) Pub. Date: Oct. 3, 2024

(54) HUMIDITY CONTROL DEVICE

(71) Applicant: R.P. Scherer Technologies, LLC, Carson City, NV (US)

(72) Inventors: Todd Anthony STUTZMAN, Overland Park, KS (US); Scott Alan MANNEBACH, Kansas City, MO (US); Alex Michael PARKER, Kansas City, MO (US); Daniela CIOLOBOC, Kansas City, MO (US)

(73) Assignee: R.P. Scherer Technologies, LLC, Carson City, NV (US)

(21) Appl. No.: 18/575,489

(22) PCT Filed: Jul. 1, 2022
(86) PCT No.: PCT/US2022/073363

§ 371 Date: Dec. 29, 2023

Related U.S. Application Data
(60) Provisional application No. 63/217,445, filed on Jul. 1, 2021.

(51) Int. Cl. F26B 21/08; F26B 21/00

(52) U.S. Cl. CPC F26B 21/08; F26B 21/004

(57) ABSTRACT

Provided are humidity control devices, systems, and methods of controlling humidity in an enclosed container. A humidity control device can comprise a cap configured to attach to a container; a first tubular member passing through the cap to form a first portion of the first tubular member and a second portion of the first tubular member, the first portion comprising a proximal end extending away from the cap and the second portion comprising an inlet configured to receive a fluid, wherein when the cap is attached to the container, the first portion is within the container and the second portion is outside of the container, wherein the proximal end of the first tubular member comprises an outlet for delivering the fluid to an interior space of the container.

### CROSS-REFERENCE TO RELATED APPLICATIONS

This application is a U.S. national stage application under 35 U.S.C. § 371 of International Application No. PCT/US2022/073363, filed Jul. 1, 2022, which claims the benefit of U.S. Provisional Application No. 63/217,445 filed Jul. 1, 2021. The entire contents of each priority application is incorporated herein by reference.

### FIELD

The present disclosure generally relates to humidity control devices and systems, and more particularly, to humidity control devices and systems for pharmaceutical manufacturing processes.

### BACKGROUND

The efficiency of a manufacturing process is greatly dependent on the ability of the materials throughout the process to transfer from one unit to another. For example, manufacturing processes that include micro- or nano-particles may face flowability challenges that can be caused by moisture in the surrounding air. A greater humidity (i.e., due to an increased amount of moisture in the surrounding air) can cause the particles to absorb some of the moisture and stick to equipment or to each other. Thus, a high or uncontrolled humidity can cause poor flowability, which can lead to clogging, equipment malfunction, inconsistent product quality, etc.

### SUMMARY

Provided herein are humidity control devices and systems for use in manufacturing processes. Also included are methods of controlling humidity in an enclosed container of a manufacturing process. The humidity control devices, systems, and methods described can increase the flowability of micro- and nanoparticles, which can minimize the amount of downtime, equipment malfunction, and inconsistent quality due to material clogging, sticking, and poor flowability. In some embodiments, the humidity control devices provided may be used in pharmaceutical manufacturing processes, such as those that include roller compaction, tablet compression, and/or encapsulation.

Specifically, in a roller compaction process, poor flowability due to uncontrolled humidity can cause variable ribbon integrity. Variable ribbon integrity can cause different particle size distributions of granules which can impact flow downstream, dissolution of the finished product, lubrication efficiency in final blend and changes in porosity/solid fraction of the granules.

In a tablet compression process, poor flowability can cause inconsistent weights. Inconsistent weights can lead to unacceptable content uniformity or potency values that are out of specification. This can also impact tablet hardness, friability, and the ability to apply aqueous film coat as the next step in most processes.

Further, poor flowability can adversely affect capsule filling processes by causing inconsistent weights. Inconsistent weights can lead to unacceptable content uniformity and/or potency values that are out of specification.

Accordingly, the humidity control devices, systems, and methods provided herein can help achieve and maintain a desired humidity during a manufacturing process. The humidity control devices provided herein can also aerate material in a manufacturing process to improve flowability. By achieving and maintaining a predetermined humidity level, the materials in a manufacturing process may be able to more effectively flow downstream. Increased flowability of the materials can help minimize clogging and malfunction of processing equipment, and can also minimize inconsistent uniformity.

Additionally, in some manufacturing processes, hygroscopic materials are used. Hygroscopic materials absorb or adsorb water from the surrounding environment. Thus, optimal processing conditions for hygroscopic materials generally include low humidity. However, conventional systems for properly handling hygroscopic materials require special air handling units with sophisticated dehumidification systems. These systems are costly and timely to retrofit existing facilities.

In some embodiments, humidity control devices, systems, and methods are configured to be used with manufacturing processes that use micro- or nanoparticles. In some embodiments, the humidity control devices provided are configured to be used with pharmaceutical manufacturing processes. Notably, the devices and systems described herein can be used with dry pharmaceutical manufacturing processes (e.g., roller compaction or direct blend) to achieve higher drug loads than would otherwise be possible. For example, drug loads of 40 wt. % or greater can be achieved with humidity control devices and systems according to some embodiments.

In some embodiments, the humidity control devices described may be configured to attach to a container such as a hopper or a bin. In some embodiments, humidity control devices may be configured to attach to two or more different containers (e.g., hopper, bin) that are different sizes. A humidity control device may be attached to a container at a topmost surface of the container. In some embodiments, a humidity control device may be attached at a side or at a bottom surface of the container. A humidity control device according to some embodiments can be fluidly coupled to a fluid supply. For example, the fluid supply may supply compressed air to the humidity control device. In some embodiments, the fluid supply is regulated by a flow meter.

Humidity control devices described herein include a plurality of outlets. When attached to a container, the plurality of outlets are positioned within the container. In some embodiments, the outlets are submerged in the material. In some embodiments, the outlets are positioned above an upper surface of the material, in a void or empty space of the container. In some embodiments, the humidity control device comprises one or more tubular members that pass from an exterior of the container through to an interior of the container. In some embodiments, the humidity control device comprises a plurality of branches extending form a portion of the one or more tubular members that is located within the container when the bin lid is coupled to the bin/container. Each branch includes one or more outlets at a proximal end. In some embodiments, each tubular member comprises one or more outlets at a distal end of the portion of the tubular member that is located within a container when the bin lid is coupled to the bin/container. The fluid from the fluid supply passes from the humidity control device to an interior of the container by way of the outlets. In some embodiments, each outlet comprises a nozzle.

Humidity control devices provided herein can additionally include an air vent. The air vent may include a filter. In some embodiments, a humidity control device may comprise a pressure relief valve.

In some embodiments, the depth at which the outlets extend into the container is adjustable. For example, the desired depth may depend on the size of the container, the amount of material in the container (and whether it is desired that the outlets are submerged under the surface of the material or above the surface of the material), etc.

In some embodiments, a humidity control device is provided, the device comprising: a cap configured to attach to a container; a first tubular member passing through the cap to form a first portion of the first tubular member and a second portion of the first tubular member, the first portion comprising a proximal end extending away from the cap and the second portion comprising an inlet configured to receive a fluid, wherein when the cap is attached to the container, the first portion is within the container and the second portion is outside of the container, wherein the proximal end of the first tubular member comprises an outlet for delivering the fluid to an interior space of the container.

In some embodiments of the device, the first tubular member is positioned centrally with respect to the cap.

In some embodiments of the device, the device comprises a second tubular member passing through the cap to form a first portion of the second tubular member and a second portion of the second tubular member, the first portion comprising a proximal end extending away from the cap and the second portion comprising an inlet configured to receive a fluid, wherein when the cap is attached to the container, the first portion is within the container and the second portion is outside of the container, wherein the proximal end of the second tubular member comprises an outlet for delivering the fluid to an interior space of the container.

In some embodiments of the device, each outlet comprises one or more nozzles.

In some embodiments of the device, the device comprises an air vent within the cap.

In some embodiments of the device, the air vent comprises a filter.

In some embodiments of the device, the device comprises a pressure relief valve in the cap.

In some embodiments of the device, the fluid comprises compressed air.

In some embodiments of the device, the device is configured to achieve a relative humidity within the container of less than or equal to 20%.

In some embodiments, a humidity control system is provided, the system comprising: a container; a humidity control device comprising: a cap configured to attach to the container; a first tubular member passing through the cap to form a first portion of the first tubular member and a second portion of the first tubular member, the first portion comprising a proximal end extending away from the cap and the second portion comprising an inlet configured to receive a fluid, wherein when the cap is attached to the container, the first portion is within the container and the second portion is outside of the container; and a fluid supply fluidly connected to the second portion of the tubular member of the humidity control device and configured to deliver fluid to the humidity control device, wherein the proximal end of the first tubular member comprises an outlet for delivering the fluid to an interior space of the container.

In some embodiments, a humidity control device is provided, the device comprising: a cap configured to attach to a container; a central tubular member passing through the cap to form a first portion of the central tubular member and a second portion of the central tubular member, the first portion comprising a proximal end extending away from the cap and the second portion comprising an inlet configured to receive a fluid, wherein when the cap is attached to the container, the first portion is within the container and the second portion is outside of the container; and a plurality of branches extending from the proximal end of the first portion of the central tubular member, each branch comprising a distal end at the central tubular member and a proximal end extending away from the central tubular member, wherein the proximal end of each branch comprises an outlet for delivering the fluid to an interior space of the container.

In some embodiments of the device, the plurality of branches includes four, five, or six branches.

In some embodiments of the device, each outlet comprises one or more nozzles.

In some embodiments of the device, the device comprises an air vent within the cap.

In some embodiments of the device, the air vent comprises a filter.

In some embodiments of the device, the device comprises a pressure relief valve in the cap.

In some embodiments of the device, each branch of the plurality of branches extends away from the central tubular member in a direction that is perpendicular to a direction in which the central tubular member passes through the cap.

In some embodiments of the device, each branch of the plurality of branches extends away from the central tubular member and away from the cap in a direction that is at an angle between 0 and 90 degrees to a direction in which the central tubular member passes through the cap.

In some embodiments of the device, each branch of the plurality of branches extends away from the central tubular member and away from the cap in a direction that is at an angle between 30 and 60 degrees to a direction in which the central tubular member passes through the cap.

In some embodiments of the device, the plurality of branches are equally spaced around the proximal end of the central tubular member.

In some embodiments of the device, the plurality of branches are not equally spaced around the proximal end of the central tubular member.

In some embodiments of the device, the fluid comprises compressed air.

In some embodiments of the device, the device is configured to achieve a relative humidity within the container of less than or equal to 20%.

In some embodiments, a humidity control system is provided, the system comprising: a container; a humidity control device comprising: a cap configured to attach to the container; a central tubular member passing through the cap to form a first portion of the central tubular member and a second portion of the central tubular member, the first portion within the container and comprising a proximal end extending away from the cap and the second portion outside of the container and comprising an inlet configured to receive a fluid; and a plurality of branches extending from the proximal end of the first portion of the central tubular member, each branch comprising a distal end at the central tubular member and a proximal end extending away from the central tubular member, wherein the proximal end of each branch comprises an outlet for delivering the fluid to an interior space of the container, and a fluid supply fluidly connected to the second portion of the central tubular member of the humidity control device and configured to deliver fluid to the humidity control device.

In some embodiments of the system, the system comprises a hygrometer configured to measure the humidity of fluid exiting the container.

In some embodiments of the system, the system comprises a controller configured to control the fluid flowing from the fluid supply to the humidity control device based on humidity measurements received from the hygrometer.

In some embodiments of the system, the system comprises an adjustment mechanism configured to allow the central tubular member to slide through the cap to adjust a length of the first portion and the second portion of the central tubular member, and wherein the adjustment mechanism is configured to lock the central member in place once a desired position is achieved.

In some embodiments of the system, the plurality of branches includes four, five, or six branches.

In some embodiments of the system, each outlet comprises one or more nozzles. In some embodiments of the system, the system comprises an air vent within the cap.

In some embodiments of the system, the air vent comprises a filter.

In some embodiments of the system, the system comprises a pressure relief valve in the cap.

In some embodiments of the system, each branch of the plurality of branches extends away from the central tubular member in a direction that is perpendicular to a direction in which the central tubular member passes through the cap.

In some embodiments of the system, each branch of the plurality of branches extends away from the central tubular member and away from the cap in a direction that is at an angle between 0 and 90 degrees to a direction in which the central tubular member passes through the cap.

In some embodiments of the system, each branch of the plurality of branches extends away from the central tubular member and away from the cap in a direction that is at an angle between 30 and 60 degrees to a direction in which the central tubular member passes through the cap.

In some embodiments of the system, the plurality of branches are equally spaced around the proximal end of the central tubular member.

In some embodiments of the system, the plurality of branches are not equally spaced around the proximal end of the central tubular member.

In some embodiments of the system, the fluid comprises compressed air.

In some embodiments of the system, the device is configured to achieve a relative humidity within the container of less than or equal to 20%.

In some embodiments, a method of controlling the humidity of a container is provided, the method comprising: receiving a fluid from a fluid supply; passing the fluid through a humidity control device attached to a container such that the humidity control device passes through a wall of the container, wherein the humidity control device is fluidly connected to the fluid supply; and diffusing the fluid into an interior space of a container to achieve a humidity of less than or equal to 20% relative humidity within the container.

In some embodiments, any one or more of the features, characteristics, or elements discussed above with respect to any of the embodiments may be incorporated into any of the other embodiments mentioned above or described elsewhere herein.

### BRIEF DESCRIPTION OF THE FIGURES

FIG. 1 shows a humidity control device attached to a container, according to some embodiments;

FIG. 2 shows a humidity control device, according to some embodiments;

FIG. 3 shows an image of a humidity control device, according to some embodiments;

FIG. 4 shows an image of a humidity control system including a humidity control device attached to a container, according to some embodiments; and

FIG. 5 shows a method of controlling the humidity of the interior of a container, according to some embodiments.

FIG. 6 shows a humidity control device mounted to a bin lid, according to some embodiments;

FIG. 7 shows a humidity control device mounted to a bin lid, according to some embodiments;

FIG. 8A shows a close up view of a plurality of branches extending from a central tubular member, according to some embodiments;

FIG. 8B shows a close up view of a plurality of branches extending from a central tubular member, according to some embodiments;

FIG. 9 shows a close up view of a plurality of outlets, according to some embodiments;

FIG. 10 shows discharge time data for various humidity control device configurations, according to some embodiments.

### DETAILED DESCRIPTION

Described herein are humidity control devices for use in manufacturing processes. The humidity control devices can improve the flowability of various materials (e.g., materials including microparticles, nanoparticles, etc.) by controlling the humidity of the environment surrounding the material. Humidity control devices and systems according to some embodiments can also aerate the material in a container to improve flowability of the material. Aeration facilitates flow of particles, due to the void spaces which are needed for the particles to rearrange in such a manner and move with gravitational forces.

Conventional humidity control systems required rooms or facilities with special air handlers (which are very expensive) to achieve low humidity levels of <20% relative humidity, which are necessary in many manufacturing processes. For example, some compounds (e.g., hygroscopic compounds) can only be successfully handled at such low humidity levels without compromising the stability and or potency of the compound.

Accordingly, the humidity control devices and systems according to embodiments described herein can achieve the desired processing conditions (e.g., humidity levels) necessary for optimal material flow and handling. These humidity control devices and systems can achieve such processing conditions at a lower cost, with fewer materials, and with less labor than is required to adapt an entire processing room or facility, which would otherwise be required.

In some embodiments, humidity control devices described herein may be configured to attach to a container (e.g., bin, hopper), and more specifically, a bin/container lid or cap, used during a manufacturing process. Containers that may be suitable for use with humidity control devices provided herein can include containers used for blending, storage, and/or transfer to downstream processing. Additionally, the humidity control devices and systems described are configured to be used with conventional containers. Although specific containers/bins including ports for air jets exist, these bins are expensive and often must be custom ordered. Thus, because humidity devices can be used with conventional containers that do not need to be specially ordered or manufactured, the cost associated with controlling the humidity and improving the flowability of the material is minimized. Further, because the humidity control devices can be used with conventional containers, the devices are versatile and portable, which allows them to easily be switched out from one container to another, and from one processing line to another.

Humidity control devices can improve the flowability of materials by diffusing a fluid (e.g., gas) within a processing environment. The fluid may be used to achieve and maintain a predetermined humidity. The controlled humidity and aeration of the material provided by a humidity control device can improve material flowability to minimize the incidence of clogging or malfunction of equipment. Improved flowability can also improve the content uniformity of the final product. Further, controlling the humidity of the processing environment may be particularly useful for certain materials, such as hygroscopic materials. Hygroscopic materials attract water from the surrounding environment through absorption or adsorption. When this happens, the physical properties of the hygroscopic material changes (e.g., volume, viscosity), which can negatively affect its flowability. In particular, when hygroscopic materials absorb or adsorb moisture from the surrounding environment, the cohesive properties of the hygroscopic materials increase, which decreases the flowability of the materials.

In some embodiments, humidity control devices may be used in pharmaceutical manufacturing processes, food manufacturing processes, nutraceutical processing, and any other processes that include the transfer of powder or granulated material. Further, the humidity control devices provided herein can be used in dry processes, wet processes, and/or oxygen sensitive or other processes requiring a controlled atmosphere. For example, dry pharmaceutical manufacturing processes (e.g., roller compaction or direct blend) can achieve higher drug loads using humidity control devices/systems according to some embodiments than would otherwise be possible. For example, drug loads of up to 90 wt. % or greater can be achieved with humidity control devices and systems according to some embodiments.

A humidity control system can include a fluid supply in fluid communication with a humidity control device. The flow of fluid from the fluid supply to the humidity control device can be controlled with a flow meter. The fluid enters the humidity control device through a conduit extending from the fluid supply to the humidity control device, and out through a plurality of outlets. When attached to a container of a manufacturing process, the outlets of the humidity control device are positioned within the enclosed container. The outlets can each comprise a nozzle through which the fluid exits the device and enters the processing environment (e.g., an interior space of the container).

A humidity control system can additionally include an air vent (which can optionally include a filter), a pressure relief valve, and/or an adjustment mechanism that can adjust the depth at which the outlets extend into the container.

In some embodiments, a humidity control device of a humidity control system includes one or more tubular members that extend from an exterior of the container to an interior of the container when the humidity control device is attached to the container. In cases in which the humidity control device is attached to a top surface of a container, the one or more tubular members can extend vertically. In some embodiments, the portion of the one or more tubular members that is positioned within the container when the device is attached to a container may comprise a plurality of branches. In some embodiments, the plurality of branches extends radially from the central body. The branches each comprise a distal end, at the one or more tubular members, and a proximal end. At the proximal end of each branch is an outlet from which the fluid exits the device and enters the interior of the container.

Referring now to the drawings, like parts are marked throughout the specification and drawings with the same reference numerals, respectively. Drawing figures are not necessarily to scale and in certain views, parts may have been exaggerated for purposes of clarity.

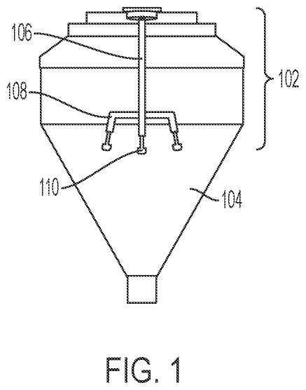

FIG. 1 shows a humidity control device 102 attached to a container 104, according to some embodiments. As shown, humidity control device 102 includes a tubular member 106, a plurality of branches 108, and a plurality of outlets 110.

Container 104 may be any enclosed chamber used during a manufacturing process. For example, container 104 may be a bin, hopper, big bag, drum, tablet press, encapsulation machine, high-shear granulator, low-shear granulator, collette gral, etc. In some embodiments, humidity control device 102 may be configured to attach to container 104 at a top location, as shown in the Figure. In some embodiments, humidity control device 102 may be configured to attach to container 104 at a side or at a bottom of container 104. In some embodiments, humidity control device 102 may be centrally attached to container 104. In some embodiments, humidity control device may be attached to container 104 offset from a center location.

Container 104 may be used in a manufacturing process for pharmaceutical compounds. In some embodiments, container 104 is configured to hold material for a pharmaceutical compound. The material can comprise excipients and/or active pharmaceutical ingredients (API). In some embodiments, the material may comprise microparticles, nanoparticles, etc. In some embodiments, the material may include a higher drug load than would otherwise be able to be achieved by using the disclosed humidity control devices. For example, the material may comprise 10-90 wt. % API. In some embodiments, the material may comprise less than or equal to 90, 80, 70, 60, 50, 40, 30, or 20 wt. % API. In some embodiments, the material may comprise more than or equal to 10, 20, 30, 40, or 50 wt. % API.

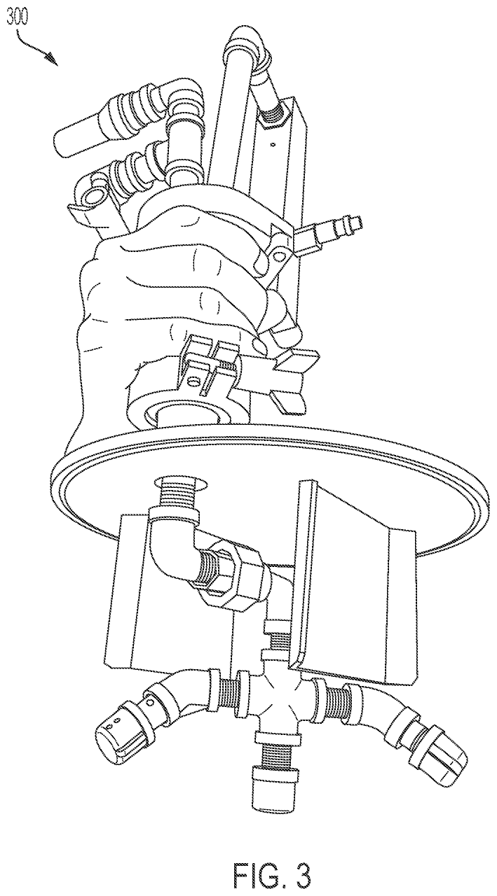

Humidity control device 102 includes a tubular member 106 that extends from an exterior of container 104 through a wall of container 104 and to an interior of container 104. In some embodiments, tubular member 106 is configured to slide in and out of container 104 to adjust the depth at which humidity control device 102 extends into container 104. In some embodiments, when humidity control device 102 is attached to a top of container 104, tubular member 106 can extend vertically into container 104. Tubular member 106 may comprise a straight shaft, as shown in FIG. 1, or tubular member 106 may comprise one or more bends to form a plurality of straight sections (e.g., as shown in FIG. 3). In some embodiments, tubular member 106 passes through a cap that is attached to container 104 at a geometric center of the cap. In some embodiments, tubular member 106 passes through a location of the cap that is not the geometric center of the cap. In some embodiments, tubular member 106 comprises one or more bends within container 104 (when humidity control device 102 is attached to container 104). In some embodiments, tubular member 106 comprises one or more bends exterior to container 104 (when humidity control device 102 is attached to container 104).

The portion of tubular member 106 that is located within container 104 (when humidity control device 102 is attached to container 104) can include a plurality of branches 108 extending radially from the tubular member 106. Each branch 108 comprises a distal end (at the tubular member 106) and a proximal end. In some embodiments, each branch extends radially from the tubular member 106 at a direction that is perpendicular to the direction at which tubular member 106 passes through the cap. In some embodiments, each branch extends from the tubular member 106 at an angle such that the proximal end of each branch faces away from an entrance point of the tubular member 106 (i.e., the point at which tubular member 106 passes through a wall of container 104).

In some embodiments, each proximal end comprises an outlet 110 from which fluid can exit the humidity control device 102 and enter the interior environment of the container 104. In some embodiments, each outlet 110 comprises a nozzle. In some embodiments, each outlet 110 comprises two or more nozzles. In some embodiments, each outlet 110 and/or branch 108 comprise two or more nozzles that may direct fluid into different directions from the device 102. In some embodiments, each outlet 110 comprises a hole from which fluid may exit device 102. In some embodiments, each branch 108 comprises a plurality of holes through which fluid may exit device 102.

In some embodiments, humidity control device 102 may not include any branches. For example, tubular member 106 may include an outlet 110 at the end of the tubular member 106 that is located within the container 104 when the humidity control device is attached to container 104.

In some embodiments, humidity control device 102 may include two, three, four, five, six, seven, eight, nine, or ten branches 108. Each branch 108 of the plurality of branches 108 may extend from tubular member 106 such that they are equally spaced around tubular member 106. In some embodiments, each branch 108 of the plurality of branches 108 may not be equally spaced around tubular member 106. In some embodiments, each branch 108 may comprise a single straight member. A single straight membered branch 108 may extend from tubular member 106 perpendicularly (with respect to the direction tubular member 106 passes through the cap) or at an angle (e.g., extending at an angle and away from tubular member 106). In some embodiments, each branch 108 may include one or more bends, or two or more straight members. For example, FIG. 1 shows branches 108 each having a bend. Stated another way, each branch 108 in FIG. 1 includes two straight members. In some embodiments, one straight member may extend perpendicularly to tubular member 106 and one straight member may extend parallel to tubular member 106. In some embodiments, one straight member may extend perpendicularly to tubular member 106 and one straight member may extend at an angle between 0 and 90 degrees with respect to the direction at which tubular member 106 passes through the cap. In some embodiments, two straight members may extend at angles between 0 and 90 degrees with respect to tubular member 106. In some embodiments, one straight member may extend parallel to the direction at which tubular member 106 passes through the cap. In some embodiments, one or more straight members of a branch 108 may extend away from tubular member 106 at an angle between 30 and 60 degrees with respect to tubular member 106. Specifically, one or more straight members of a branch 108 may extend away from tubular member 106 at an angle with respect to the direction at which tubular member 106 passes through the wall of container 104. The configuration of the branches 108 can be critical to achieve an efficient humidity control mechanism, and may depend on the type and particle size of the material, the size and shape of the container, and/or the depth at which the tubular member 106 extends in to the bin.

In some embodiments, the humidity control device may not comprise any branches extending from the tubular member 106. In some embodiments, the humidity control device may comprise a plurality of tubular members, with or without a plurality of branches extending from each of the plurality of tubular members.

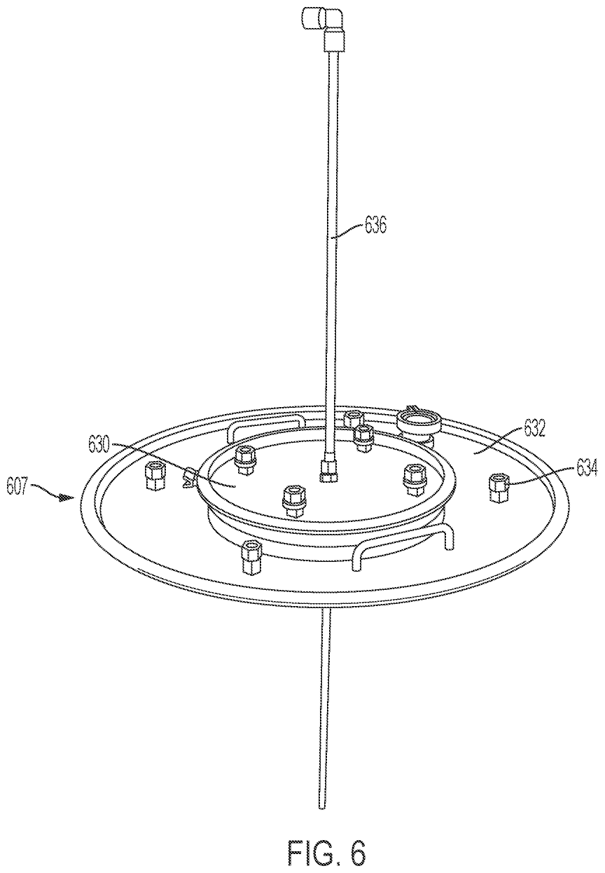

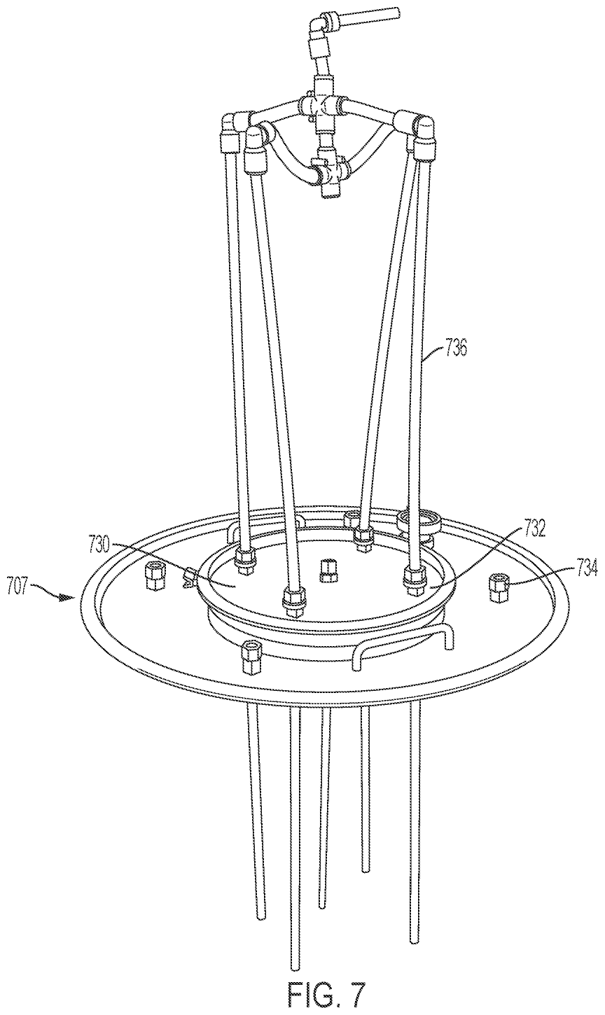

For example, in some embodiments, a humidity control device may include one or more tubular members passing through the bin lid or cap, such as that which is depicted in FIG. 6 and/or FIG. 7. For example, instead of the central tubular member 106 of FIG. 1, which includes a plurality of branches extending (e.g., radially) from the central body, a humidity control device may include a single tubular member passing through the bin lid or cap (e.g., a central tubular member without a plurality of extending branches). In this embodiment, the nozzles or holes are within the portion of the tubular member that is below the surface of the bin lid or cap, or within the bin when the lid/cap is attached to a bin. In some embodiments, instead of the central tubular member of FIG. 1, which includes a plurality of branches extending (e.g., radially) from the central body, a humidity control device may include a plurality of tubular members passing through the bin lid or cap. In some embodiments, the plurality of tubular members may pass through the bin lid/cap such that no single tube is centrally located with respect to the bin lid. In some embodiments, the tubular members may be symmetrically positioned with respect to the bin lid. In some embodiments, one or more tubular members of the plurality of tubular members may have a plurality of branches extending (e.g., radially) from a bottom portion of the tube. In some embodiments, the tubular members may not include any extending branches. In some embodiments, the nozzles or holes are within the portion of the tubular member that is below the surface of the bin lid or cap, or within the bin when the lid/cap is attached to a bin. In some embodiments, a humidity device may include 2-10, 2-8, 2-6, or 3-5 tubular members. In some embodiments, a humidity control device may include less than or equal to 10, 9, 8, 7, 6, 5, 4, or 3 tubular members. In some embodiments, a humidity control device may include more than or equal to 2, 3, 4, 5, 6, 7, 8, or 9 tubular.

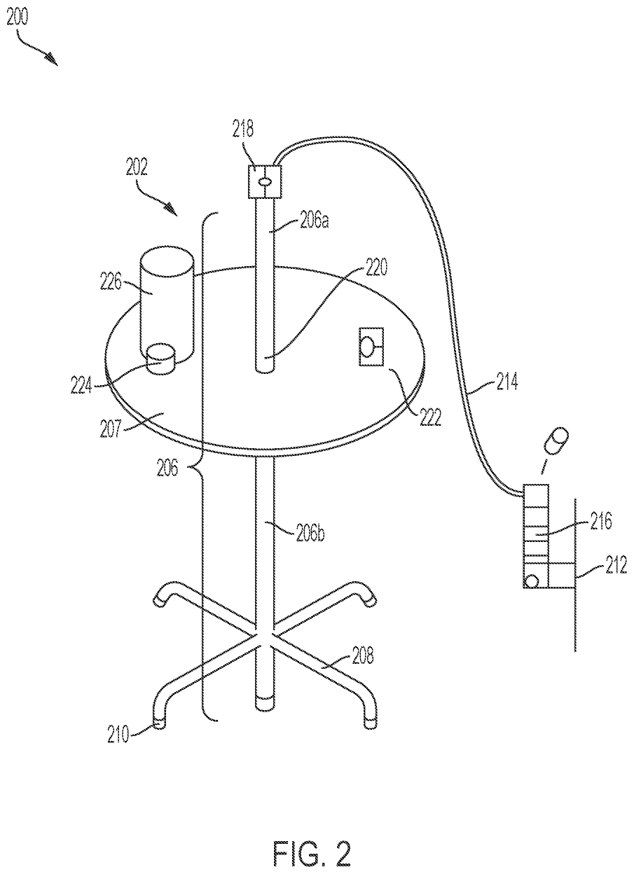

FIG. 2 shows a humidity control system 200, according to some embodiments. As shown, humidity control system 200 includes humidity control device 202 that includes tubular member 206, cap 207, a plurality of branches 208, outlets 210, pressure relief valve 222, air vent 224, filter 226, and adjustment mechanism 220. Humidity control system 200 also includes fluid supply 212, flow meter 216, conduit 214, and coupling mechanism 218.

Humidity control device 202 may include any features described above with respect to humidity control device 102 of FIG. 1. Humidity control device 202 may include a tubular member 206 that passes through cap 207. In some embodiments, cap 207 may serve as a lid for a container to which the humidity control device is attached. When attached to a container, tubular member 206 passes through an opening in a wall of the container to form an interior portion of tubular member 206 (i.e., 206b) and an exterior portion of tubular member 206 (i.e., 206a). In some embodiments, tubular member 206 may comprise a single straight shaft. In some embodiments, tubular member 206 comprises one or more bends, forming a plurality of straight sections. In some embodiments, tubular member 206 may pass through cap 207 at a geometric center of cap 207. In some embodiments, tubular member 206 passes through cap 207 at a location that is offset from the geometric center of cap 207.

The length of the interior portion 206b and the length of the exterior portion 206a may be adjusted using adjustment mechanism 220. For example, the depth at which the tubular member 206 extends into the container may depend on the specific manufacturing process, the type of material, the amount of material, whether the outlets 210 are submerged in the material or positioned above the material in the container, etc. In some embodiments, adjustment mechanism 220 may include a nut, a clamp, etc.

Interior portion 206b of tubular member 206 comprises a distal end located at cap 207 (where tubular member 206 passes through a wall of the container) and a proximal portion located furthest away from the entrance point (i.e., the point at which tubular member 206 enters the container). In some embodiments, a plurality of branches 208 extend from a location near the proximal end. Each branch includes a distal end at tubular member 206 and a proximal end. At each proximal end of each branch 208 is an outlet from which fluid passes from humidity control device 202 to the interior space of the container to which the device is attached. In some embodiments, every branch 208 of the plurality of branches 208 is the same size and shape. In some embodiments, the plurality of branches 208 may include two or more different sizes and/or shapes. In some embodiments, the proximal end of interior portion 206b of tubular member 206 also includes an outlet. For example, as shown in FIG. 2, an outlet is located both at a most proximal end of interior portion 206b as well as at the proximal ends of each branch 208 that extends from a location near the proximal end of interior portion 206b.

The branches 208 may take different forms. In some embodiments, a branch 208 may comprise a single straight section. In some embodiments, a branch 208 may comprise two or more straight sections (e.g., have one or more bends). For example, as shown in FIG. 2, each of the four branches 208 includes a single bend, or two straight sections. In some embodiments, one straight section of branch 208 may extend perpendicular to the direction in which the tubular member 206 extends through cap 207. In some embodiments, two or more straight sections of branch 208 may extend at an angle between 0 and 90 degrees or between 30 and 60 degrees with respect to the direction in which tubular member 206 extends through cap 207. In some embodiments, one or more straight sections extends in a direction away from cap 207. Each outlet can include a nozzle or sprayhead.

Humidity control device 202 also includes pressure relief valve 222, air vent 224, and filter 226. Pressure relief valve 222 is configured to relieve pressure buildup in the enclosed container. Air vent 224 is configured to let air out of the enclosed container. Filter 226 may include a filter sock, and can work in conjunction with air vent 224. Filter 226 can let air through (and out of the enclosed container) while filtering the material (e.g., microparticles, nanoparticles) such that the material remains within the enclosed container. In some embodiments, pressure relief valve 222 and air vent 224 are both located at a location on cap 207. Pressure relief valve 222 can act as a safety mechanism, for example, in the event filter 226 becomes clogged with material. If this happens, pressure relief valve 222 is configured to open and release any pressure buildup within the container. The humidity within the container can be monitored by measuring the humidity of air exiting the system through air vent 224 using a hygrometer.

To control the humidity in a container, humidity control system 200 can include a fluid supply 212. Specifically, humidity control device 202 may be fluidly coupled to a fluid supply 212. For example, fluid supply 212 may provide compressed air. Other suitable gases or fluids can include nitrogen, argon, or any other inert gas. Fluid supply 212 may be fluidly coupled to humidity control device 202 by way of conduit 214. Conduit 214 may couple to tubular member 206 of humidity control device 202 at coupling mechanism 218. In some embodiments, coupling mechanism 218 may be a quick connect coupling.

Flow meter 216 may be used to control the flow of fluid from fluid supply 212 to humidity control device 202. Flow meter 216 may be configured to measure and control the flow of fluid passing from fluid supply 212 through conduit 214 and to humidity control device 202. For example, flow meter 216 may be able to control the pressure of the fluid flowing to the humidity control device from 1-20 standard cubic feet per minute.

In some embodiments, humidity control system 200 includes a controller. The controller can be designed to control the fluid being supplied to container 204 such that a predetermined humidity level is achieved and maintained. In some embodiments, the controller is configured to receive an input from a user, such as a desired or predetermined humidity level. Based on this input, the controller is configured to control the flow of fluid from fluid supply 212 that is delivered to humidity control device 202 via conduit 214. As explained above, a hygrometer can measure the humidity of air exiting container 204 via air vent 224. This measurement can be transmitted to the controller, which can adjust the flow of fluid (e.g., by way of flow meter 216) accordingly. In some embodiments, the controller is configured to continuously monitor humidity and control the incoming fluid flow accordingly.

In some embodiments, humidity control system 200 is operated manually.

In some embodiments, a single humidity control device/system may be used with multiple different container sizes. Thus, humidity control devices and systems can be versatile and portable, since they can be used on various different containers, processing lines, with different materials, etc.

The humidity control device can easily be cleaned to enable versatility (e.g., use in different bins and/or with different materials) and to minimize cross-contamination. Additionally, the device can include features that enable thorough cleaning, such as visible threads and sanitary flanges. It can be made of sanitary materials, such as stainless steel and/or aluminum.

The humidity control devices can also be different sizes to accommodate various container sizes. For example, one size is custom designed to fit 10 L and 15 L bins. Another size can be used with 50 L and 100 L bins, and another size can be suitable for use with 200 L, 300 L, 400 L and 600 L bins. In some embodiments, humidity control devices can be configured to accommodate containers up to 1400 L or greater.

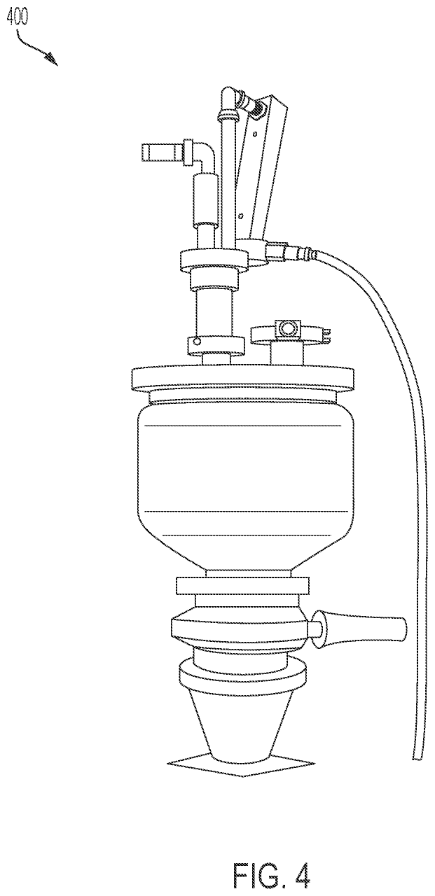

FIG. 3 shows an image of a humidity control device 300 according to some embodiments. As shown, the tubular member of the humidity control device of FIG. 3 includes at least two bends below the cap, and passes through a location of the cap that is offset from the geometric center. FIG. 4 shows an image of a humidity control system 400 including a humidity control device attached to a container according to some embodiments.

### Methods of Controlling Humidity Using a Humidity Control Device

Humidity control devices and humidity control systems can be used to control the humidity of an enclosed space and aerate the material within the container to improve the material's flowability. For example, the devices and systems provided herein may be used to control the humidity of a container (e.g., bin, hopper, big bag) used in a manufacturing process. In some embodiments, the devices and systems may be used to control the humidity of a container used in a pharmaceutical manufacturing process. Controlling the humidity can improve the flowability of the material in the process, which can minimize processing challenges (e.g., clogging, malfunction) and improve product quality.

To control the humidity of an enclosed space and improve the flowability of the material in the enclosed space, a humidity device is attached to a container. When attached to the container, a fluid inlet is located at an exterior of the container and a fluid outlet is located at an interior of the container. The humidity control device can form an airtight seal with the container. Fluid enters the humidity control device from a fluid supply which is fluidly connected to the fluid inlet of the humidity control device. The fluid passes through the humidity control device, and out through a fluid outlet of the humidity control device. Thus, the humidity control device diffuses fluid into the enclosed space (i.e., container) to aerate the material (e.g., comprising microparticles, nanoparticles). The humidity control device can also control the humidity as needed. In some embodiments, humidity control devices can control the humidity of an enclosed space to 1-75, 5-50, 5-30, 5-20, or 5-10%. In some embodiments, humidity control devices can control the humidity of an enclosed space to less than or equal to 75, 70, 65, 60, 55, 50, 45, 40, 35, 30, 25, 20, 15, 10, or 5%. In some embodiments, humidity control devices can control the humidity to more than or equal to 1, 5, 10, 15, 20, 25, 30, 35, 40, 45, 50, 55, 60, 65, or 70%. Conventional humidity control methods require modifying or retrofitting the processing facility; however, humidity control devices described herein can be used to control the humidity of a single container without the need to modify the processing facility. This can save significant time and money.

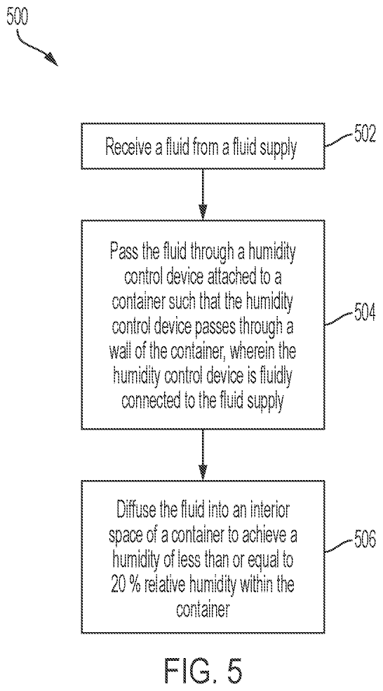

FIG. 5 shows a method 500 of controlling the humidity and thus improving the flowability of material in a container, according to some embodiments.

At step 502, a fluid is received from a fluid supply (e.g., fluid supply 212 of FIG. 2). At step 504, the fluid is passed through a humidity control device (e.g., humidity control device 102 of FIG. 1, humidity control device 202 of FIG. 2). The humidity control device is attached to a container such that the humidity control device passes through a wall of the container and is fluidly connected to the fluid supply. At step 506, the fluid is diffused into an interior space of the container from the humidity control device. This can achieve a relative humidity within the container of less than or equal to 20%.

### EXAMPLES

The disclosure is further illustrated by the following non-limiting examples.

### Example 1

One example of a humidity control device and system may be in the configuration shown in FIG. 2. As explained below, this configuration was used to develop three different-sized humidity control devices for use with different sized containers.

Tubular member 206 is a ¼ inch stainless steel pipe. Branches 108 are also made of ¼ inch stainless steel pipe. Four branches were configured in an “X” or “T” pattern, as shown in FIG. 2. At the top, coupling mechanism 218 is a quick connect coupling for receiving the air inlet. Adjustment mechanism 220 is a lock nut. Air vent 224 is a 2 inch ferrule and filter 226 is a 1 micron filter sock. Cap 207 is a tri-clover cap that can fit on a container lid. The outlets 210 are full-cone spray nozzles, and the fluid supplied by fluid supply 212 is compressed air.

The respective dimensions for each of three different sized humidity control devices are as follows: Each consists of an 8″ tri-clover cap that fits on the bin lid. The air nozzles in the “X” pattern are approximately 180 mm apart and angled 45° downward. The fifth nozzle points directly down. The total height of the adjustable pipe and air nozzles is approximately 150 mm for the 10 L and 15 L bins, 300 mm for the 50 L and 100 L bins, and 600 mm for the 200 L and 300 L bins.

### Example 2

Four different configurations of a humidity control device were tested with talc to determine each configuration's effect on the discharge time of the talc. Specifically, the discharge time measures the total amount of time for the talc to exit the bin. Each trial included the same size bin and the same amount of talc (bin 80% full of talc). In addition to a control (no humidity device), the four configurations that were tested include: one tubular member, four tubular members, a tubular member comprising a plurality of branches (i.e., antler design) above talc product, and a tubular member comprising a plurality of branches (i.e., antler design) within talc product.

The first configuration, a one-tubular member configuration, is shown in FIG. 6. As shown in the Figure, a single tubular member 636, or central body, is passed through the bin lid or cap 607. The lid 607 includes an inner lid 630 and an outer lid 632. The inner lid 630 includes five compression fittings 634 and the outer lid 632 includes four compression fittings 634. Each compression fitting 634 can be used to insert a tubular member or can be capped off. The tubular member/central body 636 includes a plurality of holes in the lower portion of the tubular member (i.e., the portion that is inserted into the bin.)

The second configuration, a four-tubular member configuration, is shown in FIG. 7. As shown in the Figure, four tubular members 736 are passed through the inner lid 732. (Lid 707, like lid 607, includes an inner lid 732 and an outer lid 734, each of which also includes a plurality of compression fittings 732.) The inner lid 730 includes five compression fittings 734 and the outer lid 732 includes four compression fittings 734. Each compression fitting 734 can be used to insert a tubular member or can be capped off. Each of the tubular members 736 includes a plurality of holes in the lower portion of the tubular member (i.e., the portion that is inserted into the bin.)

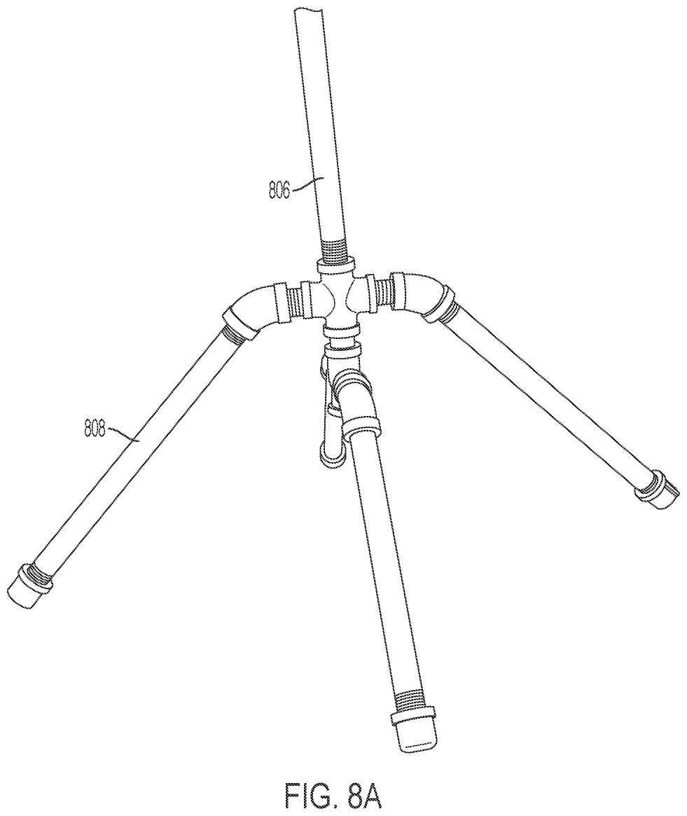

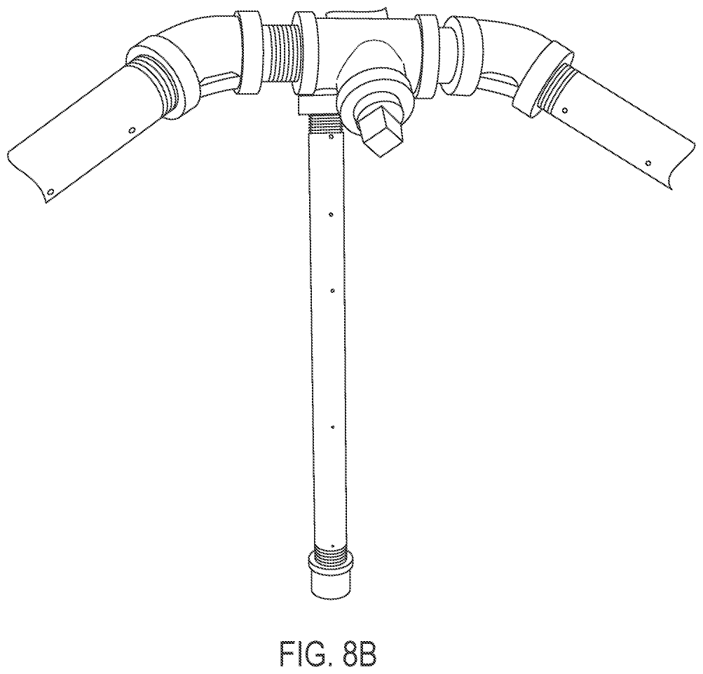

Both the third and fourth configurations (i.e., antler configuration) are represented in FIGS. 8A and 8B. As shown, this antler configuration includes a central tubular member 806 comprising a plurality of branches 808 extending from the tubular member at a downward angle. Each of the branches 808 include a plurality of holes facing inward.

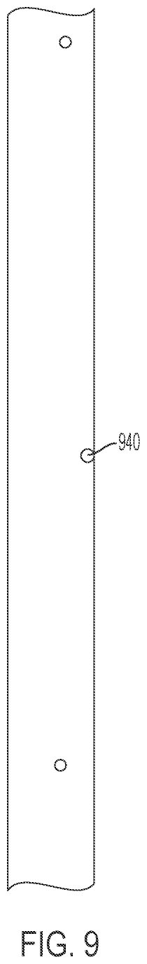

FIG. 9 shows a close-up view of the holes 940 in each of the tubular members 636, 736 and/or branches 808.

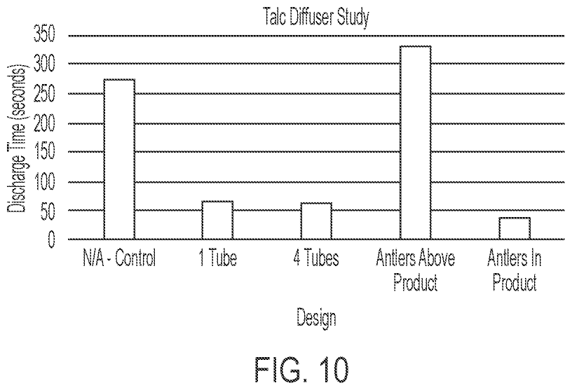

FIG. 10 shows the discharge times of each of the four configurations and a control. Note that the “antlers above product configuration” indicates that the branches 808 shown in FIGS. 8A and 8B were positioned in the bin such that they were above the talc level, and the “antlers in product” indicates that the branches 808 shown in FIGS. 8A and 8B were positioned in the bin such that they were below the talc level (i.e., inserted into the talc).

Talc was used in this example because it has relatively poor flow characteristics. As shown in the graph of FIG. 10, the shorter discharge times indicate better performance of the humidity control device/configuration. Thus, the one tubular member, four tubular members, and antlers in the product configurations were the most effective.

The foregoing description sets forth exemplary systems, methods, techniques, parameters, and the like. It should be recognized, however, that such description is not intended as a limitation on the scope of the present disclosure but is instead provided as a description of exemplary embodiments.

Although the description herein uses terms first, second, etc. to describe various elements, these elements should not be limited by the terms. These terms are only used to distinguish one element from another.

1. A humidity control device comprising:
a cap configured to attach to a container;
a first tubular member passing through the cap to form a first portion of the first tubular member and a second portion of the first tubular member, the first portion comprising a proximal end extending away from the cap and the second portion comprising an inlet configured to receive a fluid, wherein when the cap is attached to the container, the first portion is within the container and the second portion is outside of the container,
wherein the proximal end of the first tubular member comprises an outlet for delivering the fluid to an interior space of the container.

2. The device of claim 1, wherein the first tubular member is positioned centrally with respect to the cap.

3. The device of claim 1, comprising a second tubular member passing through the cap to form a first portion of the second tubular member and a second portion of the second tubular member, the first portion comprising a proximal end extending away from the cap and the second portion comprising an inlet configured to receive a fluid, wherein when the cap is attached to the container, the first portion is within the container and the second portion is outside of the container,
wherein the proximal end of the second tubular member comprises an outlet for delivering the fluid to an interior space of the container.

4. The device of claim 1, wherein each outlet comprises one or more nozzles.

5. The device of claim 1, comprising an air vent and a pressure relief valve within the cap.

6-8. (canceled)

9. The device of claim 1, wherein the device is configured to achieve a relative humidity within the container of less than or equal to 20%.

10. A humidity control system comprising:
a container; and
the humidity control device of claim 1.

11. A humidity control device comprising:
a cap configured to attach to a container;
a central tubular member passing through the cap to form a first portion of the central tubular member and a second portion of the central tubular member, the first portion comprising a proximal end extending away from the cap and the second portion comprising an inlet configured to receive a fluid, wherein when the cap is attached to the container, the first portion is within the container and the second portion is outside of the container; and
a plurality of branches extending from the proximal end of the first portion of the central tubular member, each branch comprising a distal end at the central tubular member and a proximal end extending away from the central tubular member, wherein the proximal end of each branch comprises an outlet for delivering the fluid to an interior space of the container.

12. The device of claim 11, wherein the plurality of branches includes four, five, or six branches.

13. The device of claim 11, wherein each outlet comprises one or more nozzles.

14. The device of claim 11, comprising an air vent and a pressure relief valve within the cap.

15-16. (canceled)

17. The device of claim 11, wherein each branch of the plurality of branches extends away from the central tubular member in a direction that is perpendicular to a direction in which the central tubular member passes through the cap.

18. The device of claim 11, wherein each branch of the plurality of branches extends away from the central tubular member and away from the cap in a direction that is at an angle between 0 and 90 degrees to a direction in which the central tubular member passes through the cap.

19. The device of claim 11, wherein each branch of the plurality of branches extends away from the central tubular member and away from the cap in a direction that is at an angle between 30 and 60 degrees to a direction in which the central tubular member passes through the cap.

20. The device of claim 11, wherein the plurality of branches are equally spaced around the proximal end of the central tubular member.

21-22. (canceled)

23. The device of claim 11, wherein the device is configured to achieve a relative humidity within the container of less than or equal to 20%.

24. A humidity control system comprising:
a container;
the humidity control device of claim 11;
and
a fluid supply fluidly connected to the second portion of the central tubular member of the humidity control device and configured to deliver fluid to the humidity control device.

25. The system of claim 24, comprising a hygrometer configured to measure the humidity of fluid exiting the container.

26. The system of claim 25, comprising a controller configured to control the fluid flowing from the fluid supply to the humidity control device based on humidity measurements received from the hygrometer.

27. The system of claim 24, comprising an adjustment mechanism configured to allow the central tubular member to slide through the cap to adjust a length of the first portion and the second portion of the central tubular member, and wherein the adjustment mechanism is configured to lock the central member in place once a desired position is achieved.

28-39. (canceled)

40. A method of controlling the humidity of a container comprising:
receiving a fluid from a fluid supply;
passing the fluid through a humidity control device attached to a container such that the humidity control device passes through a wall of the container, wherein the humidity control device is fluidly connected to the fluid supply; and
diffusing the fluid into an interior space of a container to achieve a humidity of less than or equal to 20% relative humidity within the container.
